(19) United States
(12) Patent Application Publication
(10) Pub. No.: US 2026/0312237 A1
(43) Pub. Date: Oct. 8, 2026

(54) Cell connector and method for producing a cell connector

(71) Applicant: ElringKlinger AG, Dettingen (DE)

(72) Inventors: Frank Ulmer, Dettingen (DE); Moritz Pausch, Dettingen (DE)

(21) Appl. No.: 19/461,312

(22) Filed: Jan. 27, 2026

Related U.S. Application Data
(63) Continuation of application No. PCT/EP2024/068597, filed on Jul. 2, 2024.

(30) Foreign Application Priority Data
Jul. 28, 2023 (DE) 10 2023 120 170.0

(51) Int. Cl. H01M 50/503; H01M 50/505

(52) U.S. Cl. CPC H01M 50/503; H01M 50/505

(57) ABSTRACT

In order to create a cell connector for electrically conductively connecting at least one first cell terminal of a first electrochemical cell and at least one second cell terminal of a second electrochemical cell, said cell connector comprising
at least one first contact region for electrically conductively connecting the cell connector to the at least one first cell terminal,
at least one second contact region for electrically conductively connecting the cell connector to the at least one second cell terminal and
at least one elastically and/or plastically deformable connection region, which is arranged in the current path between the at least one first contact region and the at least one second contact region, the cell connector requiring a small installation space and enabling a small distance of the electrochemical cells electrically conductively connected to one another by the cell connector, it is proposed that the connection region is made at least partially of a work hardened metallic material.

### RELATED APPLICATIONS

This application is a continuation of international application number PCT/EP2024/068597 filed on 2 Jul. 2024 and claims the benefit of German application number 10 2023 120 170.0 filed on 28 Jul. 2023.

The present disclosure relates to the subject matter disclosed in international application number PCT/EP2024/068597 of 2 Jul. 2024 and German application number 10 2023 120 170.0 of 28 Jul. 2023, which are incorporated herein by reference in their entirety and for all purposes.

### FIELD OF THE DISCLOSURE

The present invention relates to a cell connector for electrically conductively connecting at least one first cell terminal of a first electrochemical cell and at least one second cell terminal of a second electrochemical cell, said cell connector comprising
at least one first contact region for electrically conductively connecting the cell connector to the at least one first cell terminal,
at least one second contact region for electrically conductively connecting the cell connector to the at least one second cell terminal and
at least one elastically and/or plastically deformable connection region, which is arranged in the current path between the at least one first contact region and the at least one second contact region.

Cell connectors for electrically conductively connecting cell terminals of electrochemical cells of an electrochemical device have long been use and are configured, e.g., as aluminum rails, copper rails, bond wires, or cables.

The elastically and/or plastically deformable connection region of a cell connector may comprise a mechanical compensation element. Such a compensation element may be configured, e.g., as a corrugation, a bead, or a half-bead.

The at least one compensation element of the connection region can compensate for relative displacements of the cell terminals of the electrochemical cells electrically conductively connected to one another by the cell connector, such that the forces acting on the cell terminals and the screw or joint connections by means of which the cell terminals are connected to the cell connector due to the relative displacements do not become too large.

The at least one compensation element must be as flexible as possible but must also be able to tolerate as many load changes as possible, i.e., it must have a high operational strength.

The relative movements of the cell terminals that are to be compensated for by at least one connection region may be the result of operating loads such as shock, vibration, or so-called “swelling” of the electrochemical cells due to signs of aging.

In addition to compensating for operating loads, the at least one compensation element can also serve during the production of the electrochemical device to press the at least one first contact region or the at least one second contact region against the respectively associated first cell terminal or the respectively associated second cell terminal in order to be able to establish an electrically conductive connection in this held down position of the cell connector on the respective cell terminal, in particular by means of a welding operation, for example a laser welding operation. Here, manufacturing tolerances are compensated for with little holding down force.

In addition to providing the required mechanical flexibility, the cell connector must conduct the current between the electrochemical cells that are electrically conductively connected to one another by the cell connector, to which end the cell connector should have a lowest possible ohmic resistance, a low power loss, and as a result a low temperature.

In known cell connectors for electrically conductively connecting cell terminals of electrochemical devices, the compensation elements, for example a bead or a corrugation, are made as tall as possible (i.e. with a large extent along the contacting direction or Z-direction of the electrochemical device), as long as possible (in particular with a long plateau between two half-beads), and having large bending radii (to achieve lowest possible mechanical stresses). The requires a large installation space for the cell connector and thus a large distance of the electrochemical cells from one another, which results in a low energy density of the electrochemical device.

Often a large number of compensation elements (for example corrugations, beads, or half-beads) are used in the same connection region.

In accordance with an embodiment of the invention, a cell connector of the kind stated at the outset is created, which requires a small installation space and a small distance of the electrochemical cells electrically conductively connected to one another by the cell connector.

### SUMMARY OF THE INVENTION

In accordance with an embodiment of the invention, provision is made in a cell connector with the features of the preamble of claim 1 that the connection region is made at least partially of a work hardened metallic material.

The work hardening of the metallic material makes it possible to reduce the material thickness of the metallic material without also reducing the modulus of elasticity. This leads to a higher flexibility or a lower stiffness of the connection region.

The higher flexibility due to the work hardening of the metallic material used allows the forces acting on the connection point between a respective terminal and the cell connector to be reduced, thereby increasing the lifespan of the corresponding connection point.

Furthermore, the work hardening of the metallic material leads to a hardening in the sense of an increase in the tensile strength and the fatigue strength. This has a positive effect on the operational strength of the cell connector.

Due to the higher operational strength in the region made of the work hardened metallic material, the at least one compensation element of the connection region, for example a corrugation, a bead, or a half-bead, can be made having a lower height (i.e. having a smaller extent in the contacting direction or Z-direction of the electrochemical device) and/or having a smaller extent perpendicular to the contacting direction or Z-direction of the electrochemical device (for example with shorter plateaus between two half-beads).

Alternatively or in addition hereto, the bending radii of the at least one compensation element can be made smaller.

Each of the above-described properties leads to a reduction of the installation space required for the arrangement of the cell connector.

Preferably, at least the at least one compensation element of the connection region is made at least partially of a work hardened metallic material.

It is particularly favorable if at least one compensation element of at least one connection region of the cell connector is made entirely of a work hardened metallic material.

If the cell connector comprises a plurality of connection regions, provision is thus preferably made that all connection regions of the cell connector are made at least partially of a work hardened metallic material.

In particular, provision may be made that all connection regions of the cell connector each comprise at least one contact element, which is made at least partially of a work hardened metallic material.

It is particularly favorable if all connection regions of the cell connector each comprise at least one compensation element, which is made entirely of a work hardened metallic material.

In a preferred embodiment of the invention, provision is made that all contact elements of all connection regions of the cell connector are made at least partially of a work hardened metallic material.

It is particularly favorable if all compensation elements of all connection regions of the cell connector are made entirely of a work hardened metallic material.

The cell connector in accordance with the invention comprises at least one first contact region for electrically conductively connecting the cell connector to a first cell terminal and at least one second contact region for electrically conductively connecting the cell connector to a second cell terminal.

In principle, the cell connector may comprise any number of first contact regions for electrically conductively connecting the cell connector to a corresponding number of first cell terminals at a first electrical potential and any number of second contact regions for electrically conductively connecting the cell connector to a corresponding number of second cell terminals at a second electrochemical potential.

In this way, any number of first cell terminals can be electrically connected in series to a corresponding number of second cell terminals.

Preferably, an elastically and/or plastically deformable connection region is associated with each first contact region and/or each second contact region.

In particular, provision may be made that the cell connector comprises a web region, which is connected by way of one or more connection regions to a corresponding number of first contact regions of the cell connector and is connected by way of one or more connection regions to a corresponding number of second contact regions of the cell connector.

In principle, the work hardened metallic material may be any material that has a sufficient specific electrical conductivity for the required current-carrying capacity of the cell connector.

For example, provision may be made that the work hardened metallic material is a copper material. Such a copper material is preferably made of more than 50% copper by weight.

However, in a preferred embodiment of the invention, provision is made that the work hardened metallic material is an aluminum material.

The aluminum material preferably contains more than 50% aluminum by weight, particularly preferably more than 99.0% aluminum by weight.

The work hardening of the metallic material is preferably created by mechanically cold forming a starting material.

If the connection region of the cell connector is formed from a preferably planar starting material by means of a reshaping operation, the work hardening of the material can thus in principle take place before the reshaping operation, during the reshaping operation, or after the reshaping operation.

In order to achieve a cold forming that is as homogeneous as possible and thus a work hardening of the metallic material that is as homogeneous as possible, it is favorable if the work hardening takes place before the reshaping operation of the connection region. The work hardening is preferably effected by reducing the material thickness of a metallic starting material.

A measure for the cold forming of the starting material is the degree of deformation ε, with ε=(h₀−h₁)/h₀, wherein h₀ is the material thickness of the starting material before the work hardening and h₁ is the material thickness of the work hardened metallic material after the cold forming.

Preferably, the degree of deformation ε of the work hardened metallic material is at least 10%, in particular at least 20%, particularly preferably more than 30%, for example more than 60%.

Provision is preferably further made that the degree of deformation ε of the work hardened metallic material is less than 80%.

Work hardened metallic aluminum materials are named according to the American standard ANSI H35.1, according to the international ISO standard 2107 and according to the European standard AUF 515 with names that begin with the letter H followed by two or three digits.

The work hardening states H12 (¼ hard), H14 (½ hard), H16 (¾ hard), and H18 (hard) according to the aforementioned standards are particularly suitable as work hardened aluminum materials for the connection region of the cell connector.

It is particularly favorable for the operational strength of the cell connector if the tensile strength Rₘ of the work hardened metallic material is more than 90 N/mm², preferably more than 100 N/mm², in particular more than 120 N/mm², particularly preferably more than 140 N/mm².

Further, is has proven to be favorable for the producibility of the connection region by means of a reshaping operation if the tensile strength Rₘ of the work hardened metallic material is less than 160 N/mm².

The work hardened metallic material has preferably been hardened by means of a mechanical cold forming operation.

In particular, provision may hereby be made that the work hardened metallic material is work hardened by way of a cold rolling operation, a stamping operation, or a reshaping operation with a local reduction in the material thickness.

The work hardened material may have been soft annealed before the work hardening operation.

The cell connector may in principle comprise one layer, two layers, or more than two layers in the connection region.

In a preferred embodiment of the invention, provision is made that the cell connector is of single-layer configuration at least in the connection region.

Provision is preferably made that the connection region is made substantially entirely of the work hardened metallic material.

The connection region preferably has at least one elastically and/or plastically deformable compensation element. The compensation element is preferably made of the work hardened material.

Such a compensation element may be configured, e.g., as a corrugation, a bead, or a half-bead.

In preferred embodiments of the invention, provision is made that the connection region comprises at least one corrugation, a step, a plateau, and/or a half-bead.

A corrugation, a step, or a half-bead may extend out of the plane spanned by the connection direction and the transverse direction of the cell connector or may be of substantially planar configuration and be confined to the plane spanned by the connection direction and the transverse direction of the cell connector.

In order to reduce the thermal conductivity of the cell connector, provision may be made that the cell connector comprises at least one region of reduced cross-section in the current path between the at least one first contact region and the at least one second contact region, in which region of reduced cross-section the electrically conductive cross-section of the cell connector is reduced by at least one recess.

Such a recess may be configured, in particular, as a through-opening, which passes completely through a base body of the cell connector from a first outer side of the cell connector to a second side of the cell connector.

It is particularly favorable if the at least one region of reduced cross-section is arranged in at least one connection region of the cell connector, which is made at least partially of a work hardened metallic material.

For example, provision may be made that the region of reduced cross-section is arranged on a compensation element of such a connection region.

The region of the cell connector that is made of the work hardened metallic material may extend into the at least one first contact region and/or into the at least one second contact region, because contact regions that have a smaller material thickness are better weldable.

In preferred embodiments of the invention, provision is therefore made that the at least one first contact region and/or the at least one second contact region of the cell connector is made at least partially of a work hardened metallic material.

In particular, provision may be made that the cell connector is made substantially entirely of a work hardened metallic material.

The cell connector in accordance with the invention is suited, in particular, for use as a component of a cell contacting system for an electrochemical device that comprises a plurality of electrochemical cells, wherein the cell contacting system comprises at least one cell connector in accordance with the invention.

Such a cell contacting system in accordance with the invention is suited, in particular, for use as part of an electrochemical device that comprises a plurality of electrochemical cells and a cell contacting system in accordance with the invention.

Such an electrochemical device may be configured, in particular, as an energy store, for example for an electric vehicle or for a stationary storage application.

The electrochemical cells may be configured, in particular, as lithium ion accumulator cells.

The present invention further relates to a method for producing a cell connector for electrically conductively connecting at least one first cell terminal of a first electrochemical cell and at least one second cell terminal of a second electrochemical cell, wherein the cell connector comprises at least one first contact region for electrically conductively connecting the cell connector to the at least one first cell terminal, at least one second contact region for electrically conductively connecting the cell connector to the at least one second cell terminal and at least one elastically and/or plastically deformable connection region, which is arranged in the current path between the at least one first contact region and the at least one second contact region.

In accordance with an embodiment of the invention, such a method for producing a cell connector is created, by means of which method a cell connector is created that requires a small installation space and enables a small distance of the electrochemical cells electrically conductively connected to one another by the cell connector.

In accordance with an embodiment of the invention, a method for producing a cell connector of the kind stated above is provided, wherein the method comprises the following:
providing a metallic starting material;
work hardening at least a portion of the metallic starting material to form a work hardened metallic material; and
forming at least the at least one connection region of the cell connector by reshaping the work hardened metallic material or in the course of work hardening the metallic starting material to form the work hardened metallic material.

Provision is preferably made that the at least one connection region is formed by reshaping the metallic material that has already been work hardened before the reshaping operation.

It has proven to be particularly favorable if the metallic starting material is soft annealed before the work hardening.

Particular embodiments of the method in accordance with the invention for producing a cell connector have already been explained above in connection with particular embodiments of the cell connector in accordance with the invention for electrically conductively connecting cell terminals.

The method in accordance with the invention for producing a cell connector is suited, in particular, for the production of the cell connector in accordance with the invention.

The cell connector in accordance with the invention is preferably produced by the method in accordance with the invention for producing a cell connector.

Further features and advantages of the invention are subject matter of the subsequent description and the graphical representation of exemplary embodiments.

### BRIEF DESCRIPTION OF THE DRAWINGS

FIG. 1 shows a perspective depiction of a cell connector for electrically conductively connecting a first cell terminal of a first electrochemical cell and a second cell terminal of a second electrochemical cell, wherein the cell connector comprises a first contact region for electrically conductively connecting the cell connector to the first cell terminal, a second contact region for electrically conductively connecting the cell connector to the second cell terminal, and an elastically and/or plastically deformable connection region, which is arranged in the current path between the first contact region and the second contact region, wherein the connection region is made of a work hardened metallic material;

FIG. 2 shows a longitudinal section through the cell connector from FIG. 1;

FIG. 3 shows a graph which shows the course of the 0.2% offset yield strength (R_{p 0.2}), the course of the tensile strength (Rₘ), and the course of the elongation at break (A₁₀) of aluminum as a function of the degree of deformation or degree of cold rolling (ε);

FIG. 4 shows a perspective depiction of a contact region and a connection region of a cell connector, which are made of a work hardened metallic material, and of a web region of the cell connector, which is made of a metallic material that is not work hardened;

FIG. 5 shows a longitudinal section through the contact region, the deformation region, and the web region of the cell connector from FIG. 4;

FIG. 6 shows a longitudinal section through a first contact region, a connection region, and a second contact region of a cell connector, wherein the connection region comprises a corrugation as a compensation element;

FIG. 7 shows a longitudinal section through a first contact region, a connection region, and a second contact region of a cell connector, wherein the connection region comprises a step or half-bead as a compensation element;

FIG. 8 shows a longitudinal section through a first contact region, a connection region, and a second contact region of a cell connector, wherein the connection region comprises two half-beads (of different heights) as compensation elements;

FIG. 9 shows a longitudinal section through a first contact region, a connection region, and a second contact region of a cell connector, wherein the connection region comprises four half-beads as compensation elements;

FIG. 10 shows a longitudinal section through a first contact region, a connection region, and a second contact region of a cell connector, wherein the connection region comprises two half-beads and also a plateau arranged between the half-beads as elastically and/or plastically deformable compensation elements;

FIG. 11 shows a longitudinal section through a first contact region, a connection region, and a second contact region of a cell connector, wherein the connection region comprises two half-beads and also a plateau arranged between the half-beads as elastically and/or plastically deformable compensation elements, wherein the plateau has a greater length along a connection direction of the cell connector pointing from the first contact region to the second contact region than the plateau of the cell connector from FIG. 10; and

FIG. 12 shows a longitudinal section through a first contact region, a connection region, and a second contact region of a cell connector, wherein the connection region comprises two half-beads and also a plateau arranged between the half-beads as elastically and/or plastically deformable compensation elements, wherein the heights of the half-beads in a contacting direction of the cell connector oriented perpendicularly to the connecting direction of the cell connector have greater heights than the half-beads of the cell connector depicted in FIG. 10.

### DETAILED DESCRIPTION OF THE INVENTION

The same or functionally equivalent elements are provided with the same reference numerals in all Figures.

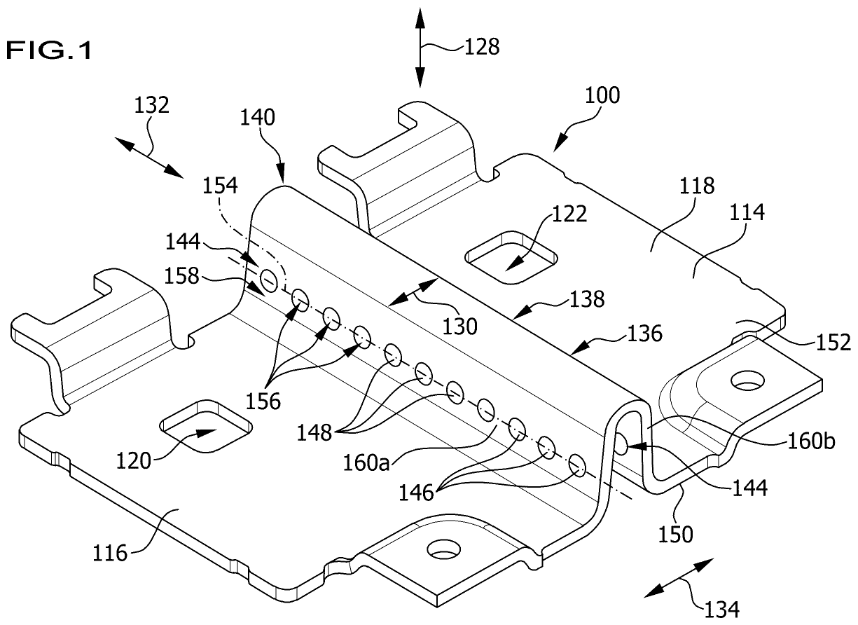

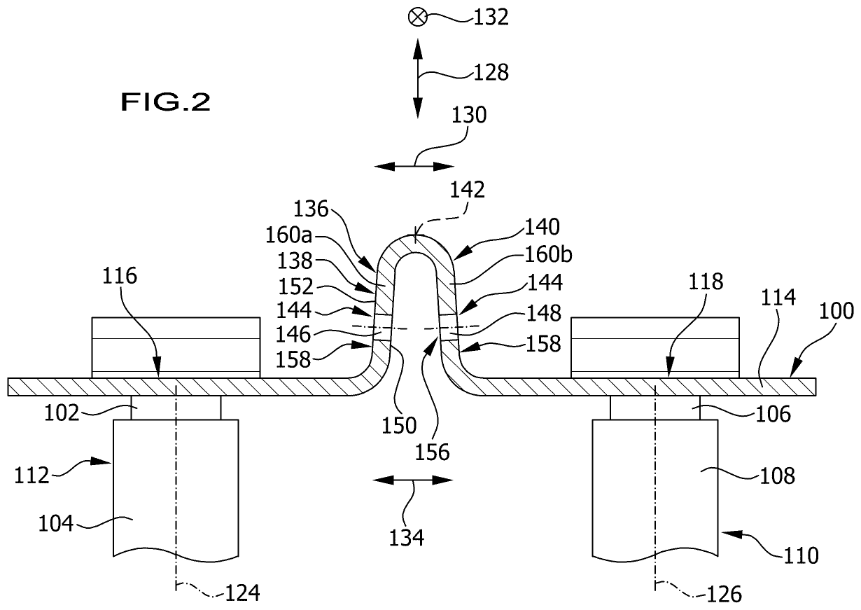

A cell connector 100 depicted in FIGS. 1 and 2 serves to electrically conductively connect a first cell terminal 102 of a first electrochemical cell 104 and a second cell terminal 106 of a second electrochemical cell 108 (see FIG. 2).

The electrochemical cells 104 and 108 form constituent parts of a battery module of an electrochemical device, denoted as a whole with 112, which may comprise a plurality of battery modules 110 that in turn each comprise a plurality of electrochemical cells 104, 108.

The electrochemical device 112 may be configured, in particular, as an accumulator, in particular as a lithium-ion accumulator.

The electrochemical cells 104, 108 of the electrochemical modules may accordingly be configured as accumulator cells, in particular as lithium-ion accumulator cells.

The first cell terminal 102 may have positive or negative polarity; the second cell terminal 106 then has the respective opposite polarity, i.e., for example the negative polarity or the positive polarity.

The cell connector 100 comprises a base body 114, which in turn has a first contact region 116 that, in the assembled state of the cell connector 100, is electrically conductively connected to the first cell terminal 102 of the first electrochemical cell 104 and a second contact region 118 that, in the assembled state of the cell connector 100, is electrically conductively connected to the second cell terminal 106 of the second electrochemical cell 108.

The base body 114 of the cell connector 100 is preferably produced as a stamped and bent part.

The base body 114 of the cell connector 100 in the embodiment depicted in FIGS. 1 and 2 is made entirely of a work hardened metallic material.

The work hardened metallic material is preferably an aluminum material.

In particular, provision may be made that the work hardened metallic material contains more than 99.0% aluminum by weight.

The degree of deformation ε of the work hardened metallic material is preferably at least 10%, in particular at least 20%, particularly preferably more than 30%, for example about 50%.

Furthermore, the degree of deformation ε of the work hardened metallic material is preferably less than 80%, in particular less than 60%.

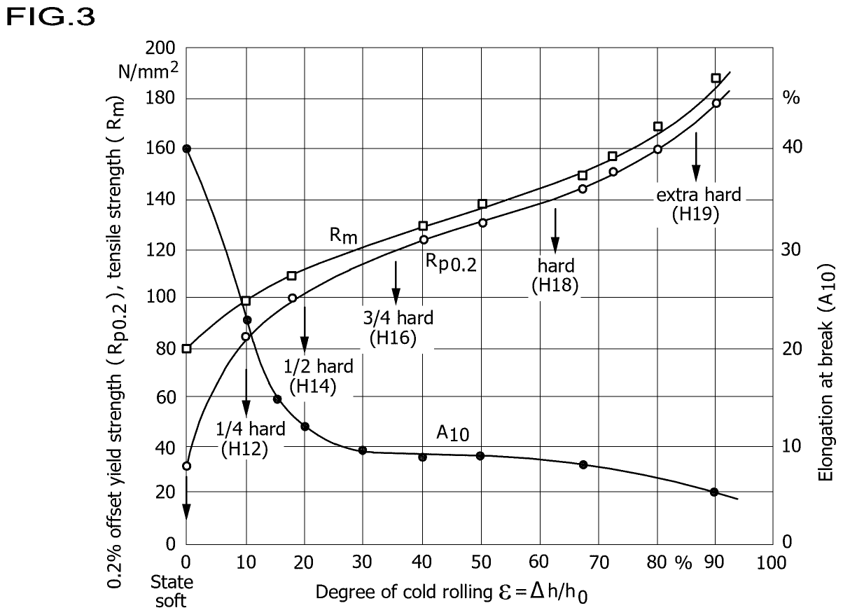

In the graph of FIG. 3, the course of the 0.2% offset yield strength (R_{p 0.2}), the tensile strength (Rₘ), and the elongation at break (A₁₀) of work hardened pure aluminum is shown as a function the degree of deformation or degree of cold rolling ε.

The degree of deformation ε results from the original material thickness h₀ of the still unhardened material and the material thickness difference Δh by which the material thickness was reduced by means of the work hardening, thus ε=Δh/h₀.

The work hardening of the metallic starting material, in particular aluminum, may hereby be performed by way of a cold rolling operation or by way of a stamping operation.

As can be seen in FIG. 3, the tensile strength Rₘ of the metallic material increases monotonically with increasing degree of deformation or degree of cold rolling ε.

If a soft annealed aluminum sheet is used as a metallic starting material, the state of which is designated with H111, then before the work hardening (i.e., at ε=0), said aluminum sheet is in a soft initial state with a tensile strength of about 80 N/mm².

If this starting material is work hardened up to a degree of deformation of 10%, then it enters the state H12 (¼ hard), with an increased tensile strength of about 100 N/mm².

If the soft annealed starting material is work hardened up to a degree of hardening of 20%, then it enters the state H14 (½ hard) in which the tensile strength is slightly above 110 N/mm².

If the starting material is work hardened up to a degree of deformation of about 36%, then it enters the state H16 (¾ hard), in which the tensile strength is increased to about 125 N/mm².

If this starting material is work hardened up to a degree of deformation of about 62%, then it enters the state H18 (hard), in which the tensile strength is about 145 N/mm².

If the starting material is work hardened up to a degree of deformation of about 86%, then it enters the state H19 (extra hard), in which the tensile strength is about 172 N/mm².

In the case of the preferred degree of deformation of ε=50%, the work hardened aluminum material is between the states H16 and H18, with a tensile strength of about 136 N/mm².

Such a work hardened aluminum material has a particularly high flexibility and fatigue strength, which is favorable for the formation of elastically and/or plastically deformable structures, in particular in the case of a stamped and bent part.

The first contact region 116 and the second contact region 118 of the cell connector 100, in the assembled state of the cell connector 100, are connected to the respectively associated cell terminal 102 and 106 by screwing or preferably by material bond.

Such a material bond is preferably established by welding, in particular laser welding, or by soldering.

In order to enable direct access, for example for measuring purposes, to the cell terminals 102 and 106 even after materially bonding the cell connector to the respective cell terminals 102 and 106, the first contact region 112 may be provided with a, for example substantially rectangular, through-opening 120 and/or the second contact region 118 of the base body 114 may be provided with a, for example substantially rectangular, through-opening 122.

In the operation of the electrochemical device 112, different temperatures and/or different thermal expansion coefficients of the cell connector 100 on the one hand and of a receiving device (not depicted) for the electrochemical cells 104, 108 on the other hand can lead to a different between a longitudinal extent of the cell connector 100 on the one hand and a change in the distance between the longitudinal axis 124 of the first cell terminals 102 and the longitudinal axis 126 of the second cell terminal 106 on the other hand. Due to a temperature change, the relative positions of the cell terminals 102, 106 connected to one another by the cell connector 100 are changed in a connecting direction 130 oriented perpendicularly to the axial direction or contacting direction 128 and/or in a transverse direction 132 oriented perpendicularly to the contacting direction 128 and perpendicularly to the connecting direction 130.

The connecting direction 130 lies in a plane that contains the longitudinal axes 124, 126 of the cell terminals 102 and 106, and extends in parallel with a longitudinal direction 134 of the cell connector 100.

In particular, the connecting direction 130 runs through a center of the through-opening 120 in the first contact region 116 and through a center of the through-opening 122 in the second contact region 118 of the cell connector 100.

Furthermore, different longitudinal extents of the electrochemical cells 104 and 108 connected to one another by the cell connector 100 can cause a change in the relative positions between the mutually connected cell terminals 102 and 106 along the contacting direction 128 of the cell terminals 102, 106.

In order to be able to compensate for such relative movements between the mutually connected cell terminals 102, 106 and thus between the first contact region 116 and the second contact region 118 of the cell connector 100 in the longitudinal direction 134 of the cell connector 100, in the transverse direction 132 of the cell connector 100, and/or in the contacting direction 128 oriented in parallel with the contacting direction 128 of the cell terminals 102, 106, the base body 114 of the cell connector 100 comprises an elastically and/or plastically deformable connection region 136, which is arranged between the first contact region 116 and the second contact region 118 in the current path of the cell connector 100 and connects the two contact regions 116 and 118 to one another.

In the embodiment of a cell connector 100 depicted in FIGS. 1 and 2, the deformable connection region 136 comprises a corrugation 140, the crest 142 of which extends in parallel with the transverse direction 132 of the cell connector 100, as an elastically and/or plastically deformable compensation element 138.

Furthermore, the cell connector comprises preferably at least one region of reduced cross-section 144, particularly preferably a plurality of regions of reduced cross-section 144, namely two regions of reduced cross-section 144 in the depicted embodiment, in the current path between the first contact region 112 and the second contact region 114, in which the electrically conductive cross-section of the cell connector 100 is reduced by in each case at least one recess 146 or preferably by in each case a plurality of recesses 146, namely in each case eleven recesses 146 in the depicted embodiment.

The recesses 146 are preferably configured as through-openings 148 in the base body 114 of the cell connector 100 and extend from a bottom side 150 of the base body 114 that faces toward the cell terminals 102, 106 to be connected to one another in the assembled state of the cell connector 100, up to a top side 152 of the base body 114 that faces away from the cell terminals 102, 106 to be connected to one another in the assembled state of the cell connector 100, through the entire base body 114 of the cell connector 100.

The recesses 146 or through-openings 148 succeed one another along a perforation line 154 of the respective region of reduced cross-section 144 and are separated from an adjacent other recess 146 or through-opening 148 or from a rim of the base body 114 of the cell connector 100 by a respective constriction of the region of reduced cross-section 144.

Preferably, at least one of the through-openings 148 of the region of reduced cross-section 144 is configured as a circular hole 156.

Particularly preferably, all through-openings 148 of the region of reduced cross-section 144 are each configured as a circular hole 156.

In principle, the through-openings 148 of the region of reduced cross-section 144 may also have a different form, for example the form of an elongate hole.

A through-opening 148 configured as a circular hole 156, however, has a lesser tendency to tear under a mechanical alternating load of the cell connector 100 than a through-opening configured as an elongate hole.

The electrically conductive cross-section of each region of reduced cross-section 144 is preferably smaller than half, in particular smaller than one third, particularly preferably smaller than one fourth, of the electrically conductive cross-section that the respective region of reduced cross-section 144 would have without the presence of the recesses 146.

Furthermore, the electrically conductive cross-section of each region of reduced cross-section 144 of the cell connector 100 is preferably smaller than half, in particular smaller than one third, particularly preferably smaller than one fourth, of the electrically conductive cross-section of a region 158 of the cell connector 100 adjoining the respective region of reduced cross-section 144 in the current path between the first contact region 116 and the second contact region 118 of the cell connector 100.

In the embodiment of a cell connector 100 depicted in FIGS. 1 and 2, the cell connector 100 has a plurality, for example more than two, regions of reduced cross-section 144 spaced at a distance from one another in the longitudinal direction 134 of the cell connector 100 in the current path between the first contact region 116 and the second contact region 118 of the cell connector 100.

In particular, provision may be made that a first region of reduced cross-section 144a is arranged in a first flank 160a of the compensation element 138, configured for example as a corrugation 140, of the connection region 136, said first flank 160a facing toward the first contact region 112 of the cell connector 100, and/or a second region of reduced cross-section 144b is arranged in a second flank 160b of the compensation element 138, configured for example as a corrugation 140, of the connection region 136, said second flank 160b facing toward the second contact region 118 of the cell connector 100.

The base body 114 of the cell connector 100 is preferably made of a material that has a thermal conductivity of at least 200 W/mK and/or a specific heat capacity of at least 800 J/kgK.

The work hardened aluminum materials described above have these properties.

The base body 114 of the cell connector 100 is preferably separated out of a flat starting material, for example by punching or cutting, for example laser cutting.

The starting material is then brought into the final shape of the base body 114 by way of a reshaping operation, for example a deep-drawing operation and/or a stamping operation, wherein the at least one compensation element 138 of the connection region 136 is formed by reshaping.

The work hardening of the metallic starting material of the cell connector 100 may in principle be performed before, during, or after the reshaping operation by means of which the at least one compensation element 138 of the connection region 136 is formed.

The separating out of the through-openings 148 of the regions of reduced cross-section 144 may also in principle take place before or after the reshaping operation by means of which the at least one compensation element 138 of the connection region 136 is formed.

The through-openings 148 are preferably separated out of the material of the base body 114, for example punched out or cut out, preferably by means of a laser.

The recesses 146 or through-openings 148 preferably have a rounded rim in order to prevent the base body 114 from tearing after the production of the recesses 146 or through-openings 148 in the base body 114.

Due to the small extent of the recesses 146 or through-openings 148 in the longitudinal direction 134 or in the connecting direction 130 of the cell connector 100, the electrical resistance of the current path of the cell connector 100 from the first contact region 116 to the second contact region 118 is only slightly increased by the regions of reduced cross-section 144.

However, the thermal conductivity of the cell connector 100 is greatly reduced by the reduction in cross-section in the region of the regions of reduced cross-section 144 of the cell connector 100.

The mechanical properties of the connection region 136 of the cell connector 100 that serve to compensate for position tolerances between the first contact region 116 and the second contact region 118 are hereby retained.

Because the significant reduction in cross-section in the regions of reduced cross-section 144 is effective only across a very short distance along the connecting direction 130 for the electric current that flows between the first contact region 116 and the second contact region 118 of the cell connector 100, the increase in the electrical resistance of the cell connector 100 is only small, preferably less than 10%.

The reduction in cross-section in the regions of reduced cross-section 144 constitutes a significant obstacle for the transmission of heat, such that the thermal resistance of the cell connector 100 in the longitudinal direction 134 or in the connecting direction 130 is increased by preferably at least 200%.

This significant increase in the thermal resistance of the cell connector 100 causes the propagation of a temperature increase from the first electrochemical cell 104 to the second electrochemical cell 108 to be significantly delayed, preferably by at least 10 seconds, in particular by at least 15 seconds, particularly preferably by at least 20 seconds.

It can thus be prevented that in the case of a “thermal runaway” (an overheating due to a malfunction of an electrochemical cell) of the first electrochemical cell 104 due to a transmission of heat across the cell connector 100, a “thermal runaway” of the second electrochemical cell 108 is also triggered.

The work hardening of the material in the region of the at least one compensation element 138 of the connection region 136 of the cell connector 100 makes it possible to use a smaller material thickness, in particular a smaller sheet metal thickness of the starting material, with the same modulus of elasticity.

This leads to a higher flexibility of the at least one compensation element 138 in the connection region 136 and to a lower stiffness thereof.

The higher flexibility of the connection region 136 due to material used to form the at least one compensation element 138 reduces the forces that, during operation of the electrochemical device, act on the connection point, for example a weld seam, between a respective cell terminal 102, 106 on the one hand and the cell connector 100 on the other hand, thereby increasing the lifespan of the connection point.

Furthermore, the work hardened material from which the at least one compensation element 138 is made has an increased tensile strength and an increased fatigue strength.

This has a positive effect on the operational strength of the connection region 136 of the cell connector 100 in the operation of the electrochemical device 112.

As already mentioned, a soft annealed sheet metal (in the state H111) is preferably used as the starting material for the production of the work hardened metallic material, said material being hardened by the work hardening operation, for example a cold rolling operation or stamping operation, selectively into one of the states H12, H14, H16, or H18.

Because the at least one compensation element 138 made of the work hardened material has a higher operational strength, the form and number of the compensation elements 138 can be adapted accordingly.

If the connection region 136 comprises a plurality of corrugations 140 as compensation elements 138, the number of corrugations can thus be reduced.

If the connection region 136 comprises at least one corrugation 140 and/or at least one half-bead as a compensation element 138, the height of the corrugation 140 or the half-bead, i.e. its extent along the contacting direction 128 of the cell connector 100, can thus be reduced, which leads to a reduction of the required installation space for the cell contacting system in the contacting direction 128.

If the connection region 136 has at least one plateau, which is arranged between two corrugations 140, between two half-beads, or between a corrugation 140 and a half-bead, the length of the plateau, i.e. its extent in the longitudinal direction 134 of the cell connector 100, is able to be reduced due to the work hardening of the material from which the connection region 136 is made.

If the connection region 136 comprises bent regions with a bending radius, said bent regions can thus be designed having smaller bending radii due to the work hardening of the material from which these bent regions are made.

This all leads to a reduction of the installation space required for the arrangement of the cell contacting system.

Provision is preferably made that the material thickness of the base body 114 of the cell connector 100 in the region of at least one compensation element 138 of the connection region 136 is mechanically reduced, for example by stamping, in order to thereby work harden the material of the respective compensation element 138.

The work hardened compensation element 138 may be a corrugation 140, a half-bead, or a bead, for example.

In the first contact region 116 and/or in the second contact region 118 of the cell connector 100, too, the material of the base body 114 of the cell connector 100 may be work hardened at least in sections and may therefore have a smaller material thickness, because contact regions 116, 118 with a smaller material thickness, i.e., with a smaller extent along the contacting direction 128, are better weldable and thus are more easily connectable to the respectively associated cell terminal 102, 106.

The cold working, in particular the stamping, increases the flexibility and the fatigue strength of the cell connector 100 while having a smaller installation space requirement.

In the embodiment of a cell connector 100 depicted in FIGS. 1 and 2, all the material of the base body 114 is work hardened.

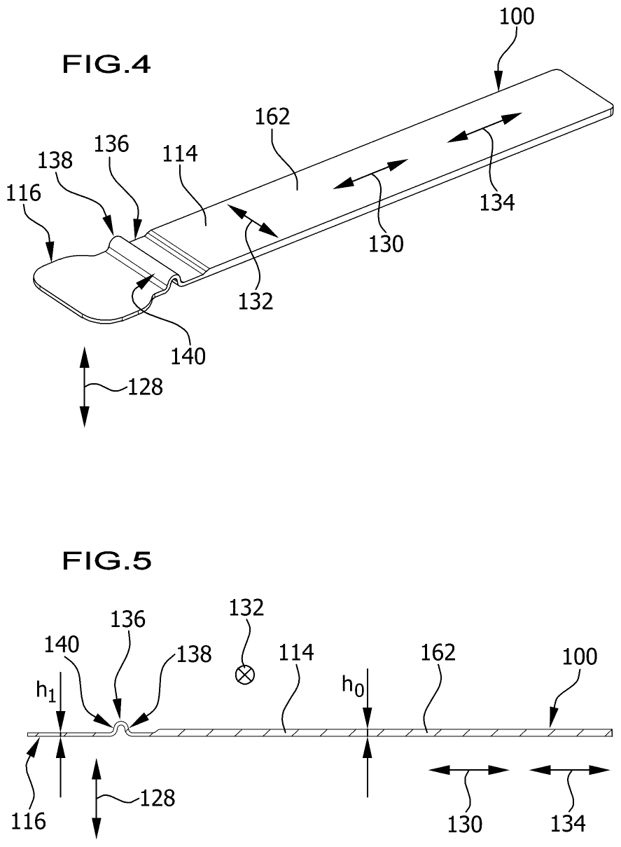

FIGS. 4 and 5 show a portion of a second embodiment of a cell connector 100 in which a first contact region 116 made of a work hardened material is connected to a web region 162 made of a material that is not work hardened by way of a connection region 136 made of a work hardened material.

At least one second contact region 118 (not depicted) is connected to the web region 162 by way of a further connection region 136 (not depicted).

As can best be seen in the longitudinal section through the first contact region 116, the connection region 136, and the web region 162 of the cell connector 100 from FIG. 4 in FIG. 5, the material thickness h₁ of the base body 114 of the cell connector 100 in the first contact region 116 and in the connection region 136 is significantly less than the material thickness h₀ of the base body 114 of the cell connector 100 in the web region 162 of the cell connector 100.

For example, provision may be made that the material thickness h₁ is about 50% of the material thickness h₀.

The stamping of the material of the first contact region 116 and the connection region 136 to the smaller material thickness h₁ can take place before, during, or after the formation of the compensation element 138 in the connection region 136 by means of a reshaping operation.

In the embodiment depicted in FIGS. 4 and 5, the connection region 136 comprises a corrugation 140 as an elastically and/or plastically deformable compensation element 138.

The connection region 136 could also comprise a half-bead instead of a corrugation 140, or the connection region 136 could comprise a plurality of compensation elements 138, for example a plurality of corrugations 140, a plurality of half-beads, or at least one corrugation 140 and at least one half-bead.

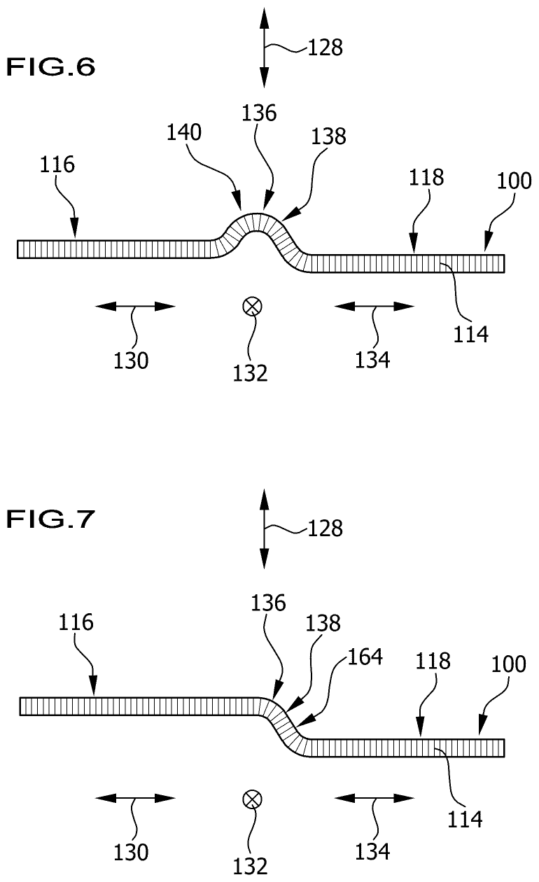

Different embodiments that show how a connection region 136 made of a work hardened material can be formed from one or more compensation elements 138 are depicted in FIGS. 6 to 12 each in a longitudinal section along the connecting direction 130 through a connection region 136.

FIG. 6 shows an embodiment of a cell connector 100 in which the connection region 136 arranged between a first contact region 116 and a second contact region 118 comprises a corrugation 140 as a compensation element 138.

FIG. 7 shows an embodiment of a cell connector 100 in which the connection region 136 arranged between a first contact region 116 and a second contact region 118 comprises a half-bead 164 as a compensation element 138.

Here, the half-bead 164 has a substantially S-shaped or Z-shaped cross-section.

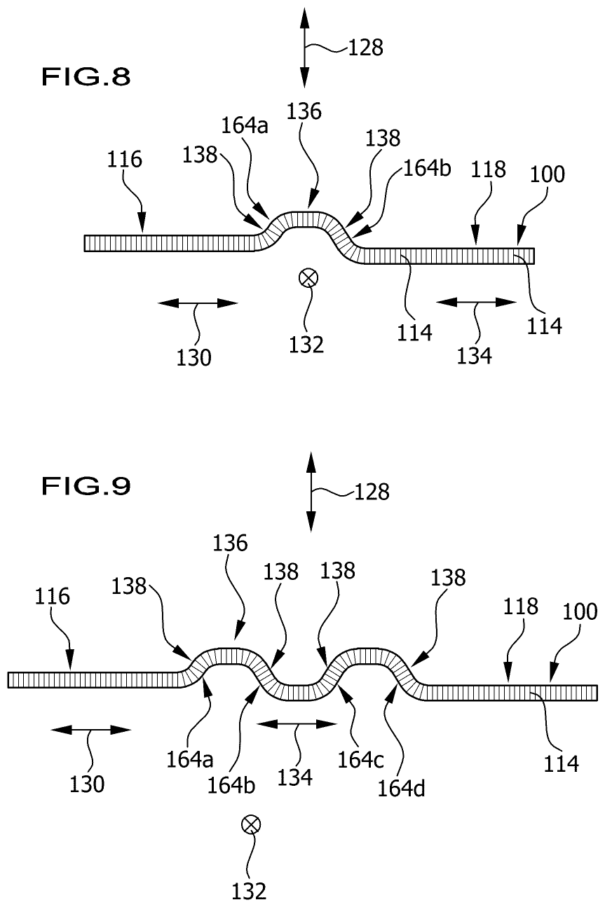

In the embodiment of a cell connector 100 depicted in FIG. 8, the connection region 136 arranged between a first contact region 116 and a second contact region 118 comprises as compensation elements 138 a first half-bead 164a, which adjoins the first contact region 116, and a second half-bead 164b, which adjoins the second contact region 118.

In the embodiment of a cell connector 100 depicted in FIG. 9, the connection region 136 arranged between a first contact region 116 and a second contact region 118 comprises as compensation elements 138 a first half-bead 164a, which adjoins the first contact region 116, a second half-bead 164b, which adjoins the first half-bead 164a, a third half-bead 164c, which adjoins the second half-bead 164b, and a fourth half-bead 164d, which adjoins the second contact region 118.

All four half-beads 164a to 164d each have a substantially S-shaped or Z-shaped cross-section.

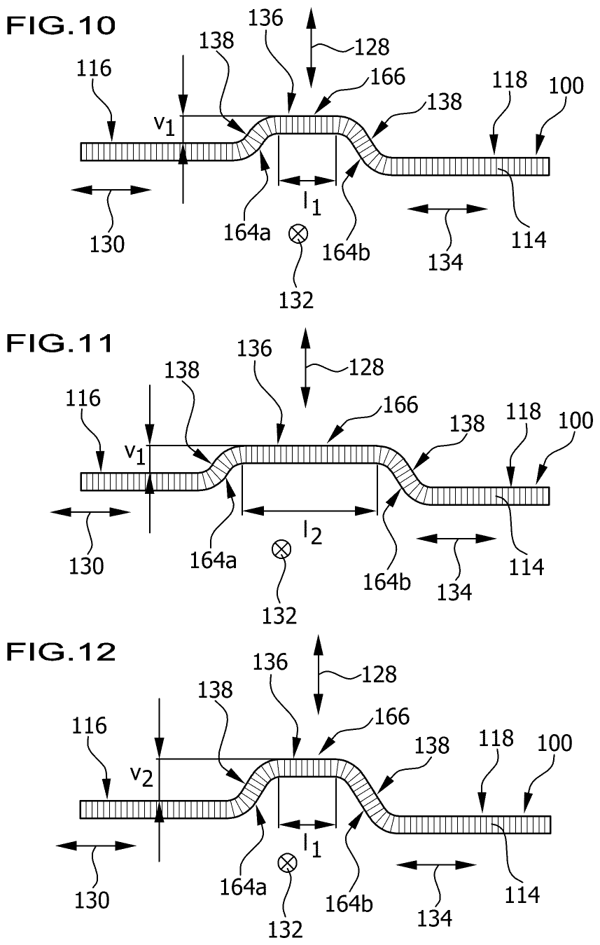

An embodiment of a cell connector 100 depicted in FIG. 10 differs from the embodiment depicted in FIG. 8 in that a plateau 166 is arranged between the two half-beads 164a and 164b that the connection region 136 comprises as elastically and/or plastically deformable compensation elements 138, said plateau 166 connecting the first half-bead 164a and the second half-bead 164b to one another.

The plateau 166 is of substantially planar configuration and is oriented substantially in parallel with the first contact region 116 and substantially in parallel with the second contact region 118 of the cell connector 100, but is offset in the contacting direction 128 both relative to the first contact region 116 and relative to the second contact region 118.

As can be seen in FIG. 10, the plateau 166 has a length l₁ between the first half-bead 164a and the second half-bead 164b along the connecting direction 130.

The plateau 166 further has an offset v₁ along the contacting direction 128 relative to the first contact region 116 of the cell connector 100.

An embodiment of a cell connector 100 depicted in FIG. 11 differs from the embodiment depicted in FIG. 10 in that the length l₂ of the plateau 166 in the embodiment from FIG. 11 is greater in than the length l₁ of the plateau 166 along the connecting direction 130 in the embodiment depicted in FIG. 10.

The offset v₁ of the plateau 166 relative to the first contact region 116 along the contacting direction 128, however, is equal in the two embodiments according to FIGS. 10 and 11.

A further embodiment of a cell connector 100 depicted in FIG. 12 differs from the embodiment depicted in FIG. 10 in that the offset v₂ of the plateau 166 relative to the first contact region 116 in the case of the embodiment depicted in FIG. 12 is greater than the offset v₁ of the plateau 166 relative to the first contact region 116 along the contacting direction 128 in the case of the embodiment depicted in FIG. 10.

By contrast, the length l₁ of the plateau 166 along the connecting direction 130 in the case of the embodiment of a cell connector 100 depicted in FIG. 12 is substantially equal to the length l₁ of the plateau 166 along the connecting direction 130 in the case of the embodiment of a cell connector 100 depicted in FIG. 10.

Of course an embodiment of a cell connector could also be created in which both the offset of the plateau 166 relative to the first contact region 116 along the contacting direction 128 as well as the length of the plateau 166 along the connecting direction 130 are different from the corresponding dimensions of the cell connector 100 depicted in FIG. 10.

1. A cell connector for electrically conductively connecting at least one first cell terminal of a first electrochemical cell and at least one second cell terminal of a second electrochemical cell, said cell connector comprising
at least one first contact region for electrically conductively connecting the cell connector to the at least one first cell terminal,
at least one second contact region for electrically conductively connecting the cell connector to the at least one second cell terminal and at least one of i) at least one elastically deformable connection region and ii) at least one plastically deformable connection region, which is arranged in the current path between the at least one first contact region and the at least one second contact region, wherein the connection region is made at least partially of a work hardened metallic material.

2. The cell connector in accordance with claim 1, wherein the work hardened metallic material is an aluminum material or a copper material.

3. The cell connector in accordance with claim 1, wherein the degree of deformation of the work hardened metallic material is at least 10%.

4. The cell connector in accordance with claim 1, wherein the tensile strength of the work hardened metallic material is more than 90 N/mm².

5. The cell connector in accordance with claim 1, wherein the work hardened metallic material is work hardened by way of a cold rolling operation, a stamping operation, or a reshaping operation with a local reduction in the material thickness.

6. The cell connector in accordance with claim 1, wherein the cell connector is of single-layer configuration at least in the connection region.

7. The cell connector in accordance with claim 1, wherein the connection region is made substantially entirely of the work hardened metallic material.

8. The cell connector in accordance with claim 1, wherein the connection region has at least one of i) at least one elastically deformable compensation element and ii) at least one plastically deformable compensation element made of the work hardened material.

9. The cell connector in accordance with claim 8, wherein the connection region comprises at least one of i) at least one corrugation, ii) a step, iii) a plateau, and iv) a half-bead.

10. The cell connector in accordance with claim 1, wherein the cell connector has at least one region of reduced cross-section in the current path between the at least one first contact region and the at least one second contact region, in which region of reduced cross-section the electrically conductive cross-section of the cell connector is reduced by at least one recess.

11. The cell connector in accordance with claim 1, wherein at least one of i) the at least one first contact region and ii) the at least one second contact region of the cell connector is made at least partially of a work hardened metallic material.

12. A cell contacting system for an electrochemical device that comprises a plurality of electrochemical cells, said cell contacting system comprising at least one cell connector for electrically conductively connecting at least one first cell terminal of a first electrochemical cell and at least one second cell terminal of a second electrochemical cell, said cell connector comprising
at least one first contact region for electrically conductively connecting the cell connector to the at least one first cell terminal,
at least one second contact region for electrically conductively connecting the cell connector to the at least one second cell terminal and
at least one of i) at least one elastically deformable connection region and ii) at least one plastically deformable connection region, which is arranged in the current path between the at least one first contact region and the at least one second contact region, wherein the connection region is made at least partially of a work hardened metallic material.

13. An electrochemical device, which comprises a plurality of electrochemical cells and a cell contacting system for an electrochemical device that comprises a plurality of electrochemical cells, said cell contacting system comprising at least one cell connector for electrically conductively connecting at least one first cell terminal of a first electrochemical cell and at least one second cell terminal of a second electrochemical cell, said cell connector comprising
at least one first contact region for electrically conductively connecting the cell connector to the at least one first cell terminal,
at least one second contact region for electrically conductively connecting the cell connector to the at least one second cell terminal and at least one of i) at least one elastically deformable connection region and ii) at least one plastically deformable connection region, which is arranged in the current path between the at least one first contact region and the at least one second contact region, wherein the connection region is made at least partially of a work hardened metallic material.

14. A method for producing a cell connector for electrically conductively connecting at least one first cell terminal of a first electrochemical cell and at least one second cell terminal of a second electrochemical cell,
wherein the cell connector comprises
at least one first contact region for electrically conductively connecting the cell connector to the at least one first cell terminal, at least one second contact region for electrically conductively connecting the cell connector to the at least one second cell terminal and at least one of i) at least one elastically deformable connection region and ii) at least one plastically deformable connection region, which is arranged in the current path between the at least one first contact region and the at least one second contact region, wherein the method comprises the following:
providing a metallic starting material;
work hardening at least a portion of the metallic starting material to form a work hardened metallic material; and
forming at least the at least one connection region of the cell connector by reshaping the work hardened metallic material or in the course of work hardening the metallic starting material to form the work hardened metallic material.

15. The method in accordance with claim 14, wherein the metallic starting material is soft annealed before the work hardening.
